(19) United States
(12) Patent Application Publication
(10) Pub. No.: US 2009/0251896 A1
(43) Pub. Date: Oct. 8, 2009

(54) Electric Lamp Adapter and Reflector

(76) Inventor: Brian Jay Conaway, Denver, CO (US)

Correspondence Address: Brian Jay Conaway, 1771 Locust St, Denver, CO, 80220, US

(21) Appl. No.: 12/129,414

(22) Filed: May 29, 2008

Related U.S. Application Data
(60) Provisional application No. 61/042,021, filed on Apr. 3, 2008.

(51) Int. Cl. F21V 7/00; A47F 5/08

(52) U.S. Cl. 362/235; 248/205.1

(57) ABSTRACT

A means of detachably coupling an adapter about the substantially male portion of a lamp base, and between a lamp body and a lamp socket body is set forth. The adapter is disc-like with a hole through which the male portion of a lamp base such as, but not limited to an Edison, GU24, or G24d type lamp base, is inserted into a related socket body. The hole in the adapter member is predetermined to be substantially congruent with the outer surface of the substantially male portion of the lamp base at a point adjacent to its junction with the lamp body. This allows the adapter member to substantially contact the outer surface of the substantially male portion of the lamp base while also being sandwiched between the top surface of the lamp body and the bottom surface of the socket body when the substantially male portion of the lamp base is fully inserted into the socket body. One of several modifications shows various reflectors being attached to the adapter. Another modification shows various lens caps detachably coupled to the reflector.

### CROSS-REFERENCED TO RELATED APPLICATIONS

This application claims the benefit of provisional patent application Ser. No. 61/042,021 filed Apr. 3, 2008 by the present inventor.

### FEDERALLY SPONSORED RESEARCH

Not Applicable

### SEQUENCE LISTING OF PROGRAM

Not Applicable

### BACKGROUND

1. Field of the Invention

This invention relates to adaptors and reflectors for lamps such as, but not limited to compact fluorescent lamps (CFLs), LED lamps, and high efficiency incandescent (HEI) lamps.

2. Prior Art

Up until very recently, the only electric lamps widely available were incandescent lamps, which are only about 15% efficient (15% of input energy converted to visible light, 85% converted to heat) and thus they operate at a very high temperature relative to their input voltage. As such, the hot filament is fully encapsulated in a glass bulb to optimize its performance and minimize fire hazards. As an added feature, this glass bulb is often shaped and textured as well as coated with different materials to, effect the shape, color, and diffusion characteristics of the resulting pattern of the light given off by the filament/bulb combination such as in the case of a spotlight or floodlight. While it has been desirable to change the look, of the incandescent lamp or the resulting color or light pattern with a secondary cover, reflector or lens, the extreme operating temperatures of high wattage incandescent lamps have lead inventors to focus on low wattage Incandescent lamps with lower operating temperatures allowing the covers to contact the glass bulb portion of the lamp, limiting their utility.

U.S. Pat. No. 2,749,432 to Dorsey 1956 discloses a means where the contour of the glass bulb is modified with various annular indentations to accept various collars to which an ornament is then attached. This invention requires a specific bulb and unique mating collar combination, since the collar would not fit standard bulbs, the utility of the invention would be greatly limited. In addition, as the wattage of the bulb increases, the resulting heat given off by the incandescent filament would transfer through the glass bulb to the collar, limiting the collar's design and material choices.

U.S. Pat. No. 3,849,640 to McCarthy 1974 discloses a means where a cover adapter is held in place against the top surface of the lamp socket and the lower side or surface of the glass bulb below the widest mid-portion of the glass bulb. Again, In order for the cover adapter to fit correctly, it would need to be designed and produced to fit a specific bulb shape and socket combination, otherwise the cover would either be loose or break the glass bulb when installed in the Edison type socket as described. Since the collar is not universal, it's utility would also be greatly limited. In both cases, as the wattage of the stated incandescent bulbs is increased, the operating temperatures is also increased, limiting the utility of the inventions to low wattage holiday lamps as stated. In addition, the compression forces applied to the thin glass bulbs by the metal or plastic collar components as the bulbs are threaded into the sockets would likely break the bulbs or put undue strain on the bulb to base connection. If the collars were made of plastic as stated, they would distort, melt or burn due to the elevated temperatures if used with incandescent bulbs over 20 watts.

In addition to incandescent lamps, a new class of electric lamps such as, but not limited to compact fluorescent lamps (CFLs), LED lamps, and high efficiency incandescent (HEI) lamps which are much more efficient and operate at much lower temperatures than standard incandescent lamps have been developed and marketed. When a unique shape or light pattern such as a floodlight, spotlight or globe is desired, the existing art permanently encapsulates the light emitting bulb portion of the lamp inside a second bulb, permanently fixed to the lamp body. This second bulb is often shaped, colored, textured or frosted to achieve the desired lighting effect. With the excessive cost and negative environmental impact of producing and discarding the second bulb each time the light emitting bulb stops working, a mechanism which would lead to the reduction or elimination of the cost and negative environmental impact of discarding this second bulb when the host bulb burns out and is discarded would be welcome.

U.S. patent to Sung et al 2001 attempts to offer a solution specific to compact fluorescent lamps (CFLs), where a flame-shaped cover, which surrounds a fluorescent tube, is detachably connected to the lamp housing. This invention offers a partial solution but also requires the cover to be mechanically coupled to specific mating features in the lamp housing, greatly limiting it's utility. Further, as stated It does not provide a solution for lamps, which are of the non-compact fluorescent lamp (CFLs) type such as but not limited to, LED lamps, and high efficiency incandescent (HEI) lamps.

### OBJECTS AND ADVANTAGES

Accordingly, several objects and advantages of my invention are:

To provide an adapter which can function with a variety of standard lamps with lamp bases such as, but not limited to the Edison, GU24, and G24d types, and their related sockets and socket bodies, eliminating the need for unique mating features to be incorporated into the lamp.

To provide an adapter which can function with lamps which incorporate a standard lamp base, lamp socket, lamp socket body, and lamp housing, such as, but not limited to, compact fluorescent lamps (CFLs), LED lamps, and high efficiency incandescent (HEI) lamps, which does not rely on contact with the glass bulb portion of the lamp.

To provide an adapter and reflector which can be used with many lamps, such as, but not limited to, compact fluorescent lamps (CFLs), LED lamps, and high efficiency incandescent (HEI) lamps in place of the fixed second glass bulb or cover, or the detachably coupled cover, which is designed to be coupled in a predisposed position with the unique mating features of the host lamp body.

### SUMMARY

This invention relates to an adapter and reflector for electric lamps such as, but not limited to compact fluorescent lamps (CFLs), LED lamps, and high efficiency incandescent (HEI) lamps with lamp bases such as, but not limited to the Edison, UG24, and G24d types, and their related sockets and socket bodies. Whereby a detachably coupled adaptor relative to said lamp base, lamp body and socket body, to which a reflector, shade, or other predetermined object or objects may be disposed is disclosed.

### BRIEF DESCRIPTION OF THE DRAWINGS

FIG. 1 is a close up side view partially in section of a combination of an Edison type screw base and socket as well as the adapter member.

FIG. 1A is a top view of the adapter member referenced in FIG. 1.

FIG. 2 is a close up side view partially in section of a combination of an Edison type screw base and socket as well as an embodiment of the adapter member with notches.

FIG. 2A is a top view of the embodiment of the adapter member with notches referenced in FIG. 2.

FIG. 3 is a close up side view partially in section of a combination of an Edison type screw base and socket as well as an embodiment of the adapter member with a protrusion member.

FIG. 3A is a top view of an embodiment of the adapter member with the protrusion member referenced in FIG. 3.

FIG. 4 is a close up side view partially in section of a combination of an Edison type screw base and socket as well a an embodiment of the adapter member with a protrusion member and notches.

FIG. 4A is a top view of an additional embodiment of the adapter with the protrusion and perimeter notches about the center hole referenced in FIG. 4.

FIG. 5 shows a side view partially in section of a combination of a GU24 type lamp and socket as well as an additional embodiment of the adapter member.

FIG. 5A is a top view of an additional embodiment of the adapter member referenced in FIG. 5.

FIG. 6 shows a side view partially in section of a combination of a G24d type lamp and socket as well as an additional embodiment of the adapter member.

FIG. 6A is a top view of an additional embodiment of the adapter member referenced in FIG. 6.

FIG. 7 is a side view partially in section of a combination of an Edison type screw base and socket as well as the adapter member referenced in FIGS. 1-4A with the addition of a conic-like reflector member.

FIG. 7A is a side view partially in section of a combination of an Edison type screw base and socket as well as the adapter member and the an additional embodiment of the conic-like reflector member referenced in FIGS. 1-4A and FIG. 7 with a detachably coupled lens cap.

FIG. 8 is a side view partially in section of a combination of an Edison type screw base and socket as well as the adapter member referenced in FIGS. 1-4A with the an additional embodiment of the conic-like reflector member with a hemispherical section.

FIG. 8A is a side view partially in section of a combination of an Edison type screw base and socket as well as the adapter member and the an additional embodiment of the conic-like reflector with a hemispherical section referenced in FIGS. 1-4A and FIG. 8 and an additional embodiment of a hemispherical shaped detachably coupled lens cap.

FIG. 9 is a side view partially in section of a combination of a GU24 type base and socket as well as an additional embodiment of the adapter member and the conic-like reflector member referenced in FIGS. 5-5A.

FIG. 9A is a side view partially in section of a combination of a GU24 type base and socket as well as the adapter member and the conic-like reflector member referenced in FIGS. 5-5A and FIG. 9 with a detachably coupled lens cap.

FIG. 10 is a side view partially in section of a combination of a G24d type base and socket as well as an additional embodiment of the adapter member and the conic-like reflector member referenced in FIGS. 6-6A.

FIG. 10A is a side view partially in section of a combination of a G24d type base and socket as well as the adapter member and the conic-like reflector member referenced in FIGS. 6-6A and FIG. 10 with a detachably coupled lens cap.

FIG. 11 is an exploded side view partially in section of a combination of an Edison type screw base and socket as well as the adapter member and the conic-like reflector member referenced in FIGS. 1-4A and FIGS. 7-7A with a detachably coupled lens cap.

FIGS. 11A-B are exploded side views partially in section of various combinations of the components in FIG. 11 used to show operational details.

FIG. 12 is an exploded side view partially in section of a combination of an Edison type screw base and socket as well as the adapter member and the conic-like reflector member referenced in FIGS. 1-4A and FIGS. 7-7A with a detachably coupled lens cap.

FIGS. 12A-B are exploded side views partially in section of various combinations of the components in FIG. 12 used to show additional operational details.

### DRAWINGS—REFERENCE NUMERALS

31A Edison type socket and socket body
31B GU24 type socket and socket body
31C G24d type socket and socket body
32A Edison type lamp body
32B GU24 type lamp body
32C G24d type lamp body
33A Edison type lamp base
33B GU24 type lamp base
33C G24d type lamp base
34 hole
35 adapter
36A Edison type socket
36B GU24 type socket
36C GU24d type socket
37A Edison type socket body
37B GU24 type socket body
37C G24d type socket body
38 adapters outside surface
39 adapter top surface
40 adapter bottom surface
41 adapter notches
42 protrusion
43 G24d type lamp base alignment notch
44A spiral lamp bulb
44B twin tube lamp bulb
45A hollow truncated conic-like reflector
45B truncated hollow conic-hemisphere like reflector
46A elliptical lens cap
46B hemisphere lens cap
47 G24d type lamp base alignment rib
49A Edison lamp base, lamp body, and lamp bulb combination
49B GU24 lamp base, lamp body, and lamp bulb combination
49C G24lamp base, lamp body, and lamp bulb combination
50 segment

### DETAILED DESCRIPTION

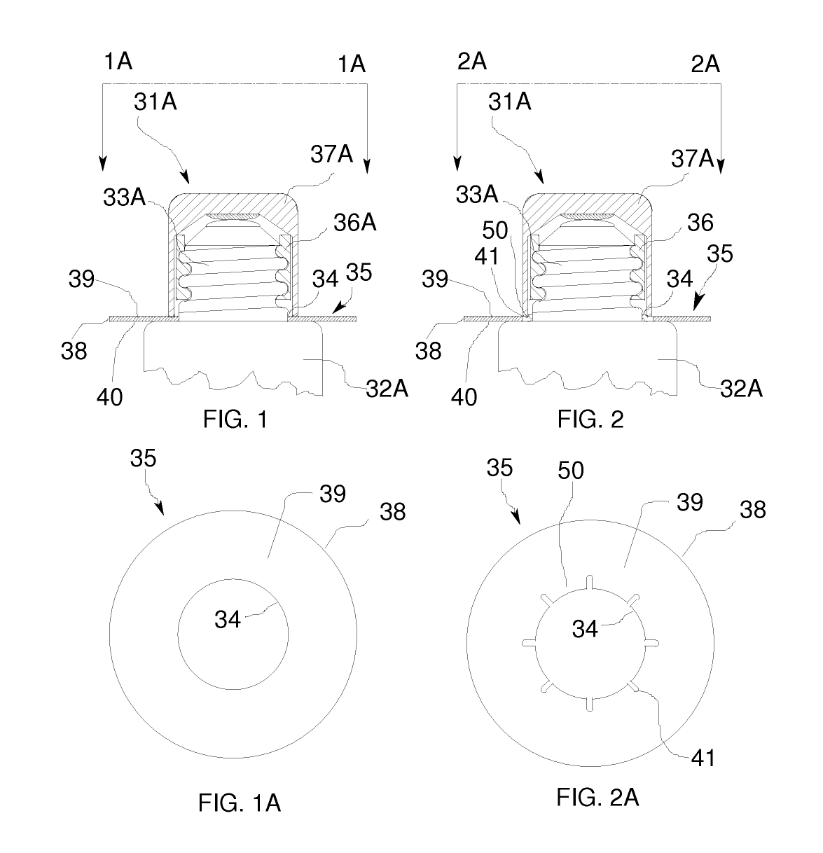

FIG. 1 shows a close-up side view partially in section of an Edison type socket and socket body 31A having an Edison type lamp body 32A and a threaded Edison type lamp base 33A inserted through hole 34 in adapter 35 and threaded into socket 36A housed in socket body 37A. As such adapter 35 with outside surface 38, top surface 39, and bottom surface 40 is disposed relative to the Edison type lamp base 33A and socket body 37A through substantially congruent proximity between the outer surface of threaded Edison type lamp base 33A at a portion of the outside surface adjacent to the junction between the substantially male portion of the Edison type lamp base 33A and the lamp body 32A and the inner surface of hole 34 when the substantially male portion of the lamp base 33A is fully inserted into the socket 36A in the socket body 37A. The adapter 35 is further disposed relative to the Edison type lamp base 33A and socket body 37A by being substantially sandwiched between the bottom surface of socket body 37A and the top surface of Edison type lamp body 32A when the substantially male portion of the Edison type lamp base 33A is fully inserted through the hole 34 in the adapter 35 and detachably coupled with the socket 36A in the socket body 37A.

FIG. 1A shows a top view of adapter 35 alone as in FIG. 1 showing hole 34, outer surface 38, top surface 39, and bottom surface 40.

FIG. 2 is an additional embodiment shown in side view partially, in section of an Edison type socket and socket body 31A having an Edison type lamp body lamp body 32A and a threaded Edison type lamp base 33A inserted through hole 34 with the addition of a plurality of notches 41 and resulting segments 50, in adapter 35 and threaded into socket 36A housed in socket body 37A. As such adapter 35 is disposed relative to the lamp base 33A and socket body 37A through substantially congruent proximity between the outer surface of threaded Edison type lamp base 33A at a portion of the outside surface adjacent to the junction between the substantially male portion of the Edison type lamp base 33A and the lamp body 32 and the inner surface of hole 34 with notches 41, which allow the segments 50 of adapter 35 between notches 41 to flex to provide a frictional fit with the substantially male portion of the Edison type lamp base 33A when the Edison type lamp base 33A is fully inserted into the Edison type socket 36A, in Edison type socket body 37A. The adapter 35 is further disposed relative to the Edison type lamp base 33A and Edison type socket body 37A by being substantially sandwiched between the bottom surface of Edison type socket body 37A and the top surface of Edison type lamp body 32A.

FIG. 2A shows a top view of the additional embodiment of adapter 35 alone as in FIG. 2, showing hole 34 with notches 41 and segments 50, outer surface 38, top surface 39 and bottom surface 40,

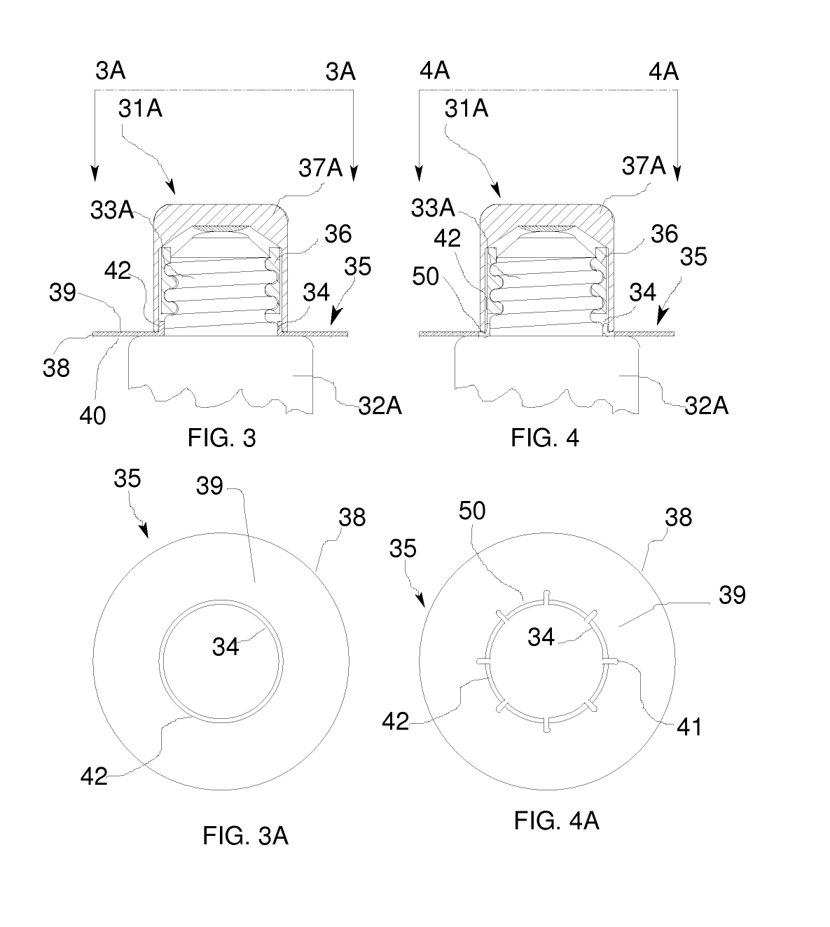

FIG. 3 is an additional embodiment shown in side view partially in section of an Edison type socket and socket body 31A having an Edison type lamp body lamp body 32A and a threaded Edison type lamp base 33A inserted through hole 34 in adapter 35 and threaded into Edison type socket 36A housed in Edison type socket body 37A. As such adapter 35 is disposed relative to the Edison type lamp base 33A and Edison type socket body 37A through substantially congruent proximity between the outer surface of threaded Edison type lamp base 33A at a portion of the outside surface adjacent to the junction between the substantially male portion of the Edison type lamp base 33A and the Edison type lamp body 32A and the inner surface of hole 34 when the Edison type lamp base 33A is fully inserted into the Edison type socket 36, in Edison type socket body 37A. The adapter 35 is further disposed relative to the Edison type lamp base 33A and Edison type socket body 37A by being substantially sandwiched between the bottom surface of Edison type socket body 37A and the top surface of Edison type lamp body 32A. The protrusion 42 is substantially connected congruently to hole 34 in the adapter 35. The top portion of the inner surface of the protrusion 42 is predetermined to be substantially congruent with the outer surface of Edison type lamp base 33A at a point substantially adjacent to the junction between the substantially male portion of the Edison type lamp base 33A and the bottom surface of the Edison type lamp body 32A, therein allowing the protrusion 42 to fit between the inner surface of the Edison type socket body 37A and the outer surface of the substantially male portion of the Edison type lamp base 33A when the substantially male portion of the Edison type lamp base 33A is fully inserted through the hole 34 and protrusion 42 in the adapter 35 and detachably coupled with the socket 36A in the socket body 37A.

FIG. 3A shows a top view of the additional embodiment of adapter 35 alone as in FIG. 3, showing hole 34 with protrusion 42, outer surface 38, top surface 39, and bottom surface 40.

FIG. 4 is an additional embodiment shown in side view partially in section of an Edison type socket and socket body 31A having an Edison type lamp body lamp body 32A and a threaded Edison type lamp base 33A inserted through hole 34 with notches 41 and segments 50, in adapter 35 and threaded into socket 36A housed in socket body 37A. As such adapter 35 is disposed relative to the Edison type lamp base 33A and Edison type socket body 37A through substantially congruent proximity between the outer surface of threaded Edison type lamp base 33A at a portion of the outside surface adjacent to the junction between the substantially male portion of the Edison type lamp base 33A and the Edison type lamp body 32A and the inner surface of hole 34 with notches 41, which allow the segments 50 of adapter 35 and protrusion 42 between notches 41 to flex to provide a frictional fit with the substantially male portion of the lamp base 33A when the lamp base 33A is fully inserted into the socket 36A, in socket body 37A. The adapter 35 is further disposed relative to the lamp base 33A and socket body 37A by being substantially sandwiched between the bottom surface of socket body 37A and the top surface of lamp body 32A. The protrusion 42 is substantially connected congruently to the, hole 34 in the adapter 35. The top portion of the inner surface of the protrusion 42 is predetermined to be substantially congruent with the outer surface of Edison type lamp base 33A at a point substantially adjacent to the junction between the substantially male portion of the Edison type lamp base 33A and the top surface of the Edison type lamp body 32A, therein allowing the protrusion to substantially fit between the inner surface of the Edison type socket body 37A and the outer surface of the substantially male portion of the Edison type lamp base 33A when the substantially male portion of the Edison type lamp base 33A is fully inserted through the hole 34 and protrusion 42 in the adapter 35 and detachably coupled with the socket 36A in the socket body 37A.

FIG. 4A shows a top view of the additional embodiment of adapter 35 alone as in FIG. 4, showing hole 34 with protrusion 42, notches 41, outer surface 38, top surface 39, and bottom surface 40.

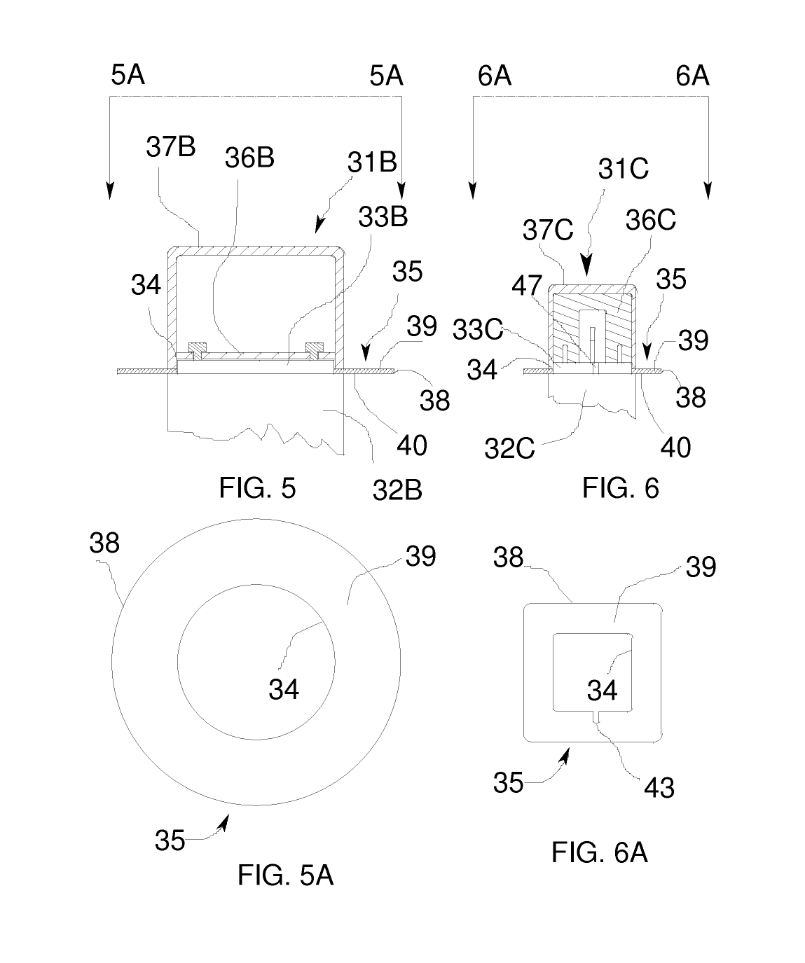

FIG. 5 is an additional embodiment shown in close-up side view, partially in section of a GU24 type socket and socket body 31B having a GU24 type lamp body 32B and a GU24 type lamp base 33B inserted through hole 34 in adapter 35 and into GU24 type socket 36B in GU24 type socket body 37B. As such adapter 35 with outside surface 38, top surface 39, and bottom surface 40, is disposed relative to GU24 type lamp base 33B and socket body 37B through substantially congruent proximity between the outer surface of GU24 type lamp base 33B at a portion of the outside surface substantially adjacent to the junction between the substantially male portion of the GU24 type lamp base 33B and the lamp body 32B and the inner surface of hole 34 when the substantially male portion of the GU24 type lamp base 33B is fully coupled with the GU24 type socket 36B in GU24 type socket body 37B. The adapter 35 is further disposed relative to the GU24 type lamp base 33B and GU24 type socket body 37B by being substantially sandwiched between the bottom surface of GU24 type socket body 37B and the top surface of GU24 type lamp body 32B when the substantially male portion of the GU24 type lamp base 33B is fully inserted into through the hole 34 in the adapter 35 and detachably coupled with the GU24 type socket 36B in the GU24 type socket body 37B.

FIG. 5A shows a top view of the additional embodiment of adapter 35 alone as in FIG. 5, showing hole 34, outer surface 38, top surface 39, and bottom surface 40.

FIG. 6 is an additional embodiment shown in close-up side view, partially in section of a G24d type socket and socket body 31C having a lamp body 32C and a lamp base 33C with G24d type lamp base alignment rib 47, inserted through hole 34 in adapter 35 with G24d type lamp base alignment notch 43 and into socket body 47B. As such adapter 35 with outside surface 38, top surface 39, and bottom surface 40, is disposed relative to G24d type lamp base 33C and socket body 37C through substantially congruent proximity between the outer surface of G24d type lamp base 33C at a portion of the outside surface substantially adjacent to the junction between the substantially male portion of the G24d type lamp base 33C and the lamp body 32C and the inner surface of hole 34 when the substantially male portion of the G24d type lamp base 33C is fully coupled with the socket body 37C. The adapter 35 is further disposed relative to the G24d type lamp base 33C and socket body 37C by being substantially sandwiched between the bottom surface of socket body 37C and the top surface of lamp body 32C when the substantially male portion of the G24d type lamp base 33C is fully inserted into through the hole 34 in the adapter 35 and detachably coupled with the socket body 37C.

FIG. 6A shows a top view of the additional embodiment of adapter 35 alone as in FIG. 6, showing hole 34 with G24d type lamp alignment notch 43, outer surface 38, top surface 39, and bottom surface 40.

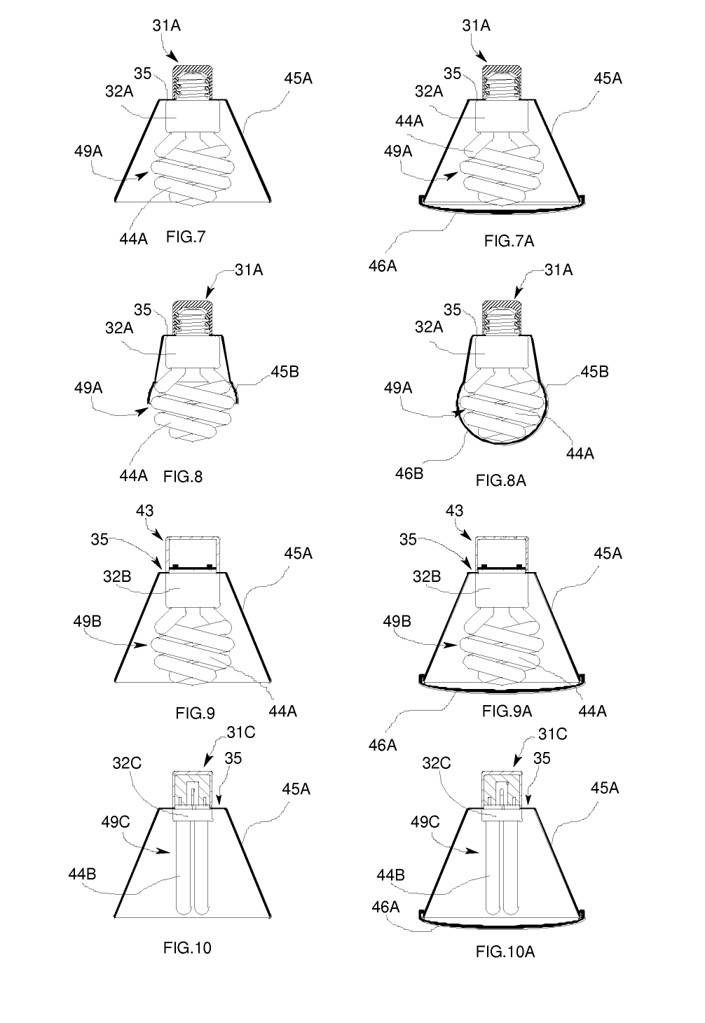

FIG. 7 shows a full side view partially in section of the adapter 35 and Edison type socket and socket body 31A and Edison lamp base, lamp body, and lamp bulb combination 49A detailed in FIGS. 1-4A with the addition of lamp bulb 44A and a shroud, shade, or reflector such as a hollow truncated conic-like reflector 45A attached to the outer surface of adapter 35.

FIG. 7A shows a full side view partially in section of the adapter 35 and Edison type socket and socket body 31A and Edison lamp base, lamp body, and lamp bulb combination 49A detailed in FIGS. 1-4A with the addition of spiral lamp bulb 44A and hollow truncated conic-like reflector 45A attached to the outer surface of adapter 35 detailed in FIG. 7 with the addition of an elliptical lens cap 46A detachably coupled to the bottom opening of hollow truncated conic-like reflector 45A.

FIG. 8 shows a full side view partially in section of one of the many embodiments of adapter 35 and Edison type socket and socket body 31A and Edison lamp base, lamp body, and lamp bulb combination 49A with the addition of spiral lamp bulb 44A and reflector 45B made from the combination of a truncated hollow hemispherical section attached to the hollow truncated conic-like section which is attached to the outer surface of adapter 35 as detailed in FIGS. 1-4A.

FIG. 8A shows a full side view partially in section of the many embodiments of adapter 35 and Edison type socket and socket body 31A and Edison lamp base, lamp body, and lamp bulb combination 49A with the addition of spiral lamp bulb 44A and reflector 45B made from the a combination of a truncated hollow shapes, such as but not limited to a hemispherical section attached to the hollow truncated conic-like section which is attached to the outer surface of adapter 35 as detailed in FIGS. 1-4A and FIG. 8, with the addition of a hemispherical lens cap 46B detachably coupled to the bottom opening of the hollow truncated hemisphere-like section of the reflector 45B.

FIG. 9 shows a full side view partially in section of the adapter 35 and GU24 type socket and socket body 31B and GU24 lamp base, lamp body, and lamp bulb combination 49B detailed in FIGS. 5-5A with the addition of spiral lamp bulb 44A and hollow truncated conic-like reflector 45A attached to the outer surface of adapter 35.

FIG. 9A shows a full side view partially in section of the adapter 35 and GU24 type socket and socket body 31B and GU24 lamp base, lamp body, and lamp bulb combination 49B detailed in FIGS. 5-5A and FIG. 9 with the addition of spiral lamp bulb 44A and a hollow truncated conic-like reflector 45A attached to the outer surface of adapter 35 detailed in FIG. 9 with the addition of an elliptical lens cap 46A detachably coupled to the bottom opening of hollow truncated conic-like reflector 45A.

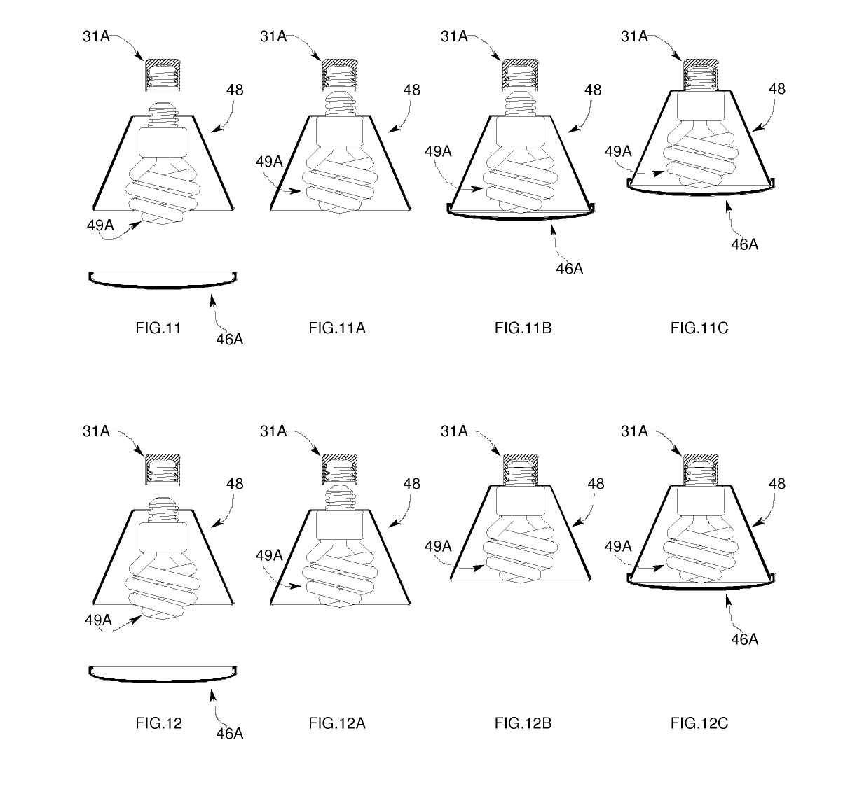

FIG. 10 shows a full side view partially in section of the adapter 35 and G24d type socket and socket body 31C and G24d lamp base, lamp body, and lamp bulb combination 49C detailed in FIGS. 6-6A with the addition of twin-tube lamp bulb 44B and hollow truncated conic-like reflector 45A attached to the outer surface of adapter 35.

FIG. 10A shows a full side view partially in section of the adapter 35 and G24d type socket and socket body 31C and G24d lamp base, lamp body, and lamp bulb combination 49C detailed in FIGS. 6-6A and FIG. 10 with the addition of twin-tube lamp bulb 44B and hollow truncated conic-like reflector 45A attached to the outer surface of adapter 35 detailed in FIG. 10 with the addition of an elliptical lens cap 46A detachably coupled to the bottom opening of hollow truncated conic-like reflector 45A.

### Operation

### FIGS. 11-11C and 12-12C

There are many methods of using this device in it's various embodiment, some of which have been detailed, along with various types of lamp and socket combinations, some of which have also been detailed. One of many such methods is detailed in FIGS. 11-11C. FIG. 11 shows the Edison type lamp base of the lamp base, lamp body, and lamp bulb combination 49, partially inserted through the hole in the adapter portion of the combination adapter and reflector 48. FIG. 11A shows the Edison type lamp base of the lamp base, lamp body, and lamp bulb combination 49, inserted through the hole in the adapter portion of the combination adapter and reflector 48 until the lamp base contacts the combination adapter and reflector 48. FIG. 11B shows the elliptical lens-cap 46A then detachably coupled to the combination adapter and reflector 48, before the lamp base portion of the lamp base, lamp body, and lamp bulb combination 49 is coupled with the Edison type socket and socket body 31A. FIG. 11C shows the elliptical lens-cap 46A detachably coupled to the combination adapter and reflector 48, after the lamp base portion of the lamp base, lamp body, and lamp bulb combination 49 is coupled with the Edison type socket and socket body 31A.

Another of the many methods is detailed in FIGS. 12 and 12A-12C. FIG. 12 is the same as FIG. 11, and is shown for reference to FIGS. 12A-12C. FIG. 12A shows the Edison type lamp base of the lamp base, lamp body, and lamp bulb combination 49, inserted through the hole in the adapter portion of the combination adapter and reflector 48 until the lamp base contacts the combination adapter and reflector 48. FIG. 12B shows the lamp base portion of the lamp base, lamp body, and lamp bulb combination 49 inserted through the hole in the adapter portion of the combination adapter and reflector 48 until the lamp base contacts the combination adapter and then the lamp base of the lamp base, lamp body, and lamp bulb combination 49 is then coupled with the Edison type socket and socket body 31A. FIG. 12C shows the combination detailed in FIG. 12B with the addition of the elliptical lens-cap 46A detachably coupled to the combination adapter and reflector 48

### ADVANTAGES

From the description above, a number of advantages of my electric lamp adapter and reflector become evident:

A) Because the combination adapter and reflector 48 can reflect the light out of a fixture such as a recessed ceiling fixture it can provide benefit with or without a lens cap. In addition, because the process can be reversed when the bulb portion of the lamp base, lamp body, and lamp bulb combination 49 stops working, it reduces the cost of bulb replacement while also reducing the environmental impact when a flood-lamp, spot-lamp, or other lamps with fixed secondary glass bulbs are discarded.

B) Because the combination adapter and reflector 48 also shrouds the lamp bulb and lamp body of the lamp base, lamp body, and lamp bulb combination 49 it provides protection for the lamp bulb against breakage, as any impact forces are transferred through the lens, reflector, or adapter to the lamp base and not the glass lamp bulb.

C) Because the shape and size of the hole 34 in adapter 35 can be configured to function with an unlimited variety of standard lamps such as, but not limited to Edison 49A, GU24 49B, and G24d 49C types, as well as their associated socket bodies, the utility of the device is quite broad.

D) Because the hole 34 in adapter 35 can be uniquely configured with the addition of protrusion 42, notches 41, or segments 50, to function with standard lamps such as, but not limited to Edison 49A, GU24 49B, and G24d 49C types, as well as their associated socket bodies, the utility of the device is quite broad.

E) Because the device provides an easy and continent means of using different adapter, reflector, and lens combinations to change the look of standard lamps such as, but not limited to, Edison 49A, GU24 49B, or G24d 49C types, as well as changing the color, pattern, and other visual features of the reflector and resulting light, the utility of the device is quite broad.

### CONCLUSIONS RAMIFICATIONS, AND SCOPE

Accordingly, the reader will see that the adapter portion of this invention can be used as the universal mounting and positioning method for a great number of items such as but not limited to reflectors, shades, and shrouds to control the color, pattern, and intensity of the light from a common source. In addition, the reflector, shade, or shroud can be configured to provide a decorative element of the lamp as well as providing impact protection for the glass bulb. The invention also allows for the device to be reusable, reducing cost and environmental impact over the current state of the art. It also allows the user to change the bulb to a different wattage as well as the lens and reflector combination, or remove the lens all together, in order to obtain different decorative effects.

Although the description above contains many specificities, these should not be construed as limiting the scope of the invention but as merely providing illustrations of some of the presently preferred embodiments of this invention. For example the adapter hole can have other shapes such as oval, rectangular, etc.; the protrusion can have other shapes, and the notches can vary in size, shape, and number; the reflector can be elliptical, rectangular, etc.; the lens can be attach to the reflector through threads, mechanical interlock, adhesive, etc. Thus the scope of the invention should be determined by the appended claims and their legal equivalents, rather then by the examples given.

What is claimed:

1. A means of detachably coupling an adapter in a disposed position relative to an electric lamp and socket combination comprising:
a) A lamp comprising:
a lamp base with a substantially male portion
Said substantially male portion having at least an outer surface a top surface and a bottom surface.
a lamp body
Said lamp body having at least an outside surface a top surface and a bottom surface.
A lamp bulb
Said lamp bulb being the portion of the lamp from which light is emitted.
b) A socket body comprising:
a bottom surface
a socket cavity with an interior surface
Said cavity designed to detachably couple with said substantially male portion of said lamp base.
c) A disc-like adapter comprising:
a top surface;
a bottom surface;
an outer surface;
a hole
Said hole predetermined to be substantially congruent with said outer surface of said substantially male portion of said lamp base.
Wherein said hole in said adapter member is predetermined to be substantially congruent with said outer surface of said substantially male portion of said lamp base substantially near the junction between said substantially male portion of said lamp base and said lamp body allowing said adapter member to be additionally sandwiched substantially between said top surface of said lamp body and said bottom surface of said socket body when said substantially male portion of said lamp base is detachably coupled with said socket body.
Whereby a means of detachably coupling an adaptor relative to said lamp base said lamp body and said socket body to which a reflector shade or other predetermined object or objects may be disposed is disclosed.

2. A means as set forth in claim 1 wherein said lamp base member and said lamp body member are integral.

3. A means as set forth in claim 1 wherein a protrusion having at least a top surface a bottom surface an inner surface and an outer surface is substantially connected congruent to said hole in said adapter member and where said inner surface of said protrusion is predetermined to be substantially congruent with said outer surface of said substantially male portion of said lamp base at a point adjacent to said junction between said substantially male portion of said lamp base and said top surface of said lamp body therein allowing said protrusion to fit between said inner surface of said socket body and said outer surface of said substantially male portion of said lamp base when said substantially male portion of said lamp base is fully inserted into said socket body.

4. A means as set forth in claim 2 wherein said adapter member and said protrusion are integral.

5. A means as set forth in claim 1 wherein said adapter contains at least one notch which interrupts said hole creating at least one segment in said adapter which improve the ability of said adapter to conform to said outer surface of said male portion of said lamp base.

6. A means as set forth in claim 1 wherein at least a portion of said adapter is made from an elastic material allowing the shape of said hole to distort and conform to said outer surface of said substantially male portion of said lamp base.

7. A means as set forth in claim 1 wherein at least a portion of said adapter is made from a elastic material allowing said adapter to distort due to compression forces when sandwiched between said socket body and said lamp body when said substantially male portion of said lamp base is fully inserted into said cavity of said socket body.

8. A means as set forth in claim 1 wherein a substantially hollow reflector with shapes such as, but not limited to a truncated cone, a truncated sphere, a truncated hemisphere, or a combination of hollow geometric shapes comprising:
An inner surface;
An outer surface;
A top surface;
A top opening;
A bottom surface;
A bottom opening
Said inner surface at said top surface being connected to said outer surface of said adapter.

9. A means as set forth in claim 6 wherein said adapter member and said reflector are integral.

10. A means as set forth in claim 6 wherein a lens cap is detachably coupled to said reflector at said bottom opening in said bottom surface.

11. A means as set forth in claim 6 wherein a lens cap is permanently coupled to said reflector at said bottom opening in said bottom surface.
